(19) United States
(12) Patent Application Publication
(10) Pub. No.: US 2024/0349213 A1
(43) Pub. Date: Oct. 17, 2024

(54) MEASUREMENT METHOD AND APPARATUS, AND TERMINAL

(71) Applicant: VIVO MOBILE COMMUNICATION CO., LTD., Dongguan (CN)

(72) Inventor: Li CHEN, Dongguan (CN)

(73) Assignee: VIVO MOBILE COMMUNICATION CO., LTD., Dongguan (CN)

(21) Appl. No.: 18/752,741

(22) Filed: Jun. 24, 2024

Related U.S. Application Data
(63) Continuation of application No. PCT/CN2022/141047, filed on Dec. 22, 2022.

(30) Foreign Application Priority Data
Dec. 28, 2021 (CN) 202111630647.9

(51) Int. Cl. H04W 56/00; H04W 24/10; H04W 36/08

(52) U.S. Cl. CPC H04W 56/0015; H04W 24/10; H04W 36/08

(57) ABSTRACT

A measurement method and apparatus, and a terminal are provided. The measurement method includes: obtaining, by a terminal, measurement performance of a first object. The first object includes any one of the following: a Cell Defining Synchronization Signal Block (CD SSB) of a first Bandwidth Part (BWP) and a Non Cell Defining Synchronization Signal Block (NCD SSB) of a second BWP; or the NCD SSB of the second BWP. The first BWP is a BWP includes a CD SSB, and the second BWP is a BWP includes an NCD SSB. The measurement method further includes controlling, by the terminal, Radio Resource Management (RRM) measurement according to the measurement performance of the first object. In the embodiments of this application, load balancing can be implemented on a network side.

### CROSS-REFERENCE TO RELATED APPLICATIONS

This application is a continuation of International Application No. PCT/CN2022/141047, filed on Dec. 22, 2022, which claims priority to Chinese Patent Application No. 202111630647.9, filed on Dec. 28, 2021. The entire contents of each of the above-referenced applications are expressly incorporated herein by reference.

### TECHNICAL FIELD

This application pertains to the field of communication technologies, and specifically relates to a measurement method and apparatus, and a terminal.

### BACKGROUND

In the related art, a terminal controls Radio Resource Management (RRM) measurement according to measurement performance of a Cell Defining Synchronization Signal and PBCH block (CD SSB). When a Non Cell Defining Synchronization Signal and PBCH block (NCD SSB) is configured in a system, if the terminal performs all or a part of operations such as receiving of System Information (SI), paging receiving, performing of Random Access Channel (RACH), and/or cell selection or reselection on the NCD SSB, to implement RRM measurement control, the terminal frequently needs to perform Radio Frequency (RF) retuning between an initial Bandwidth Part (BWP) and a separate initial BWP. Consequently, power consumption of the terminal increases, a service interruption probability increases, system performance decreases, and the like.

### SUMMARY

Embodiments of this application provide a measurement method and apparatus, and a terminal, so that load balancing can be implemented on a network side.

According to a first aspect, a measurement method is provided, including:
obtaining, by a terminal, measurement performance of a first object, where the first object includes any one of the following: a cell defining synchronization signal block CD SSB of a first bandwidth part BWP and a non cell defining synchronization signal block NCD SSB of a second BWP; and a non cell defining synchronization signal block NCD SSB of a second bandwidth part BWP; and the first BWP is a BWP including a CD SSB, and the second BWP is a BWP including an NCD SSB; and
controlling, by the terminal, RRM measurement according to the measurement performance of the first object.

According to a second aspect, a measurement apparatus is provided, including:
an obtaining module, configured to obtain measurement performance of a first object, where the first object includes any one of the following: a cell defining synchronization signal block CD SSB of a first bandwidth part BWP and a non cell defining synchronization signal block NCD SSB of a second BWP; and a non cell defining synchronization signal block NCD SSB of a second bandwidth part BWP; and the first BWP is a BWP including a CD SSB, and the second BWP is a BWP including an NCD SSB; and
a measurement module, configured to control RRM measurement according to the measurement performance of the first object.

According to a third aspect, a terminal is provided. The terminal includes a processor and a memory, the memory stores a program or an instruction that can be run on the processor, and the program or the instruction is executed by the processor to implement the steps of the method according to the first aspect.

According to a fourth aspect, a terminal is provided, including a processor and a communication interface. The processor is configured to obtain measurement performance of a first object, where the first object includes any one of the following: a cell defining synchronization signal block CD SSB of a first bandwidth part BWP and a non cell defining synchronization signal block NCD SSB of a second BWP; and a non cell defining synchronization signal block NCD SSB of a second bandwidth part BWP; and the first BWP is a BWP including a CD SSB, and the second BWP is a BWP including an NCD SSB; and control RRM measurement according to the measurement performance of the first object.

According to a fifth aspect, a measurement system is provided, including a network side device and a terminal. The terminal may be configured to perform the steps of the measurement method according to the first aspect.

According to a sixth aspect, a readable storage medium is provided. The readable storage medium stores a program or an instruction, and the program or the instruction is executed by a processor to implement the steps of the method according to the first aspect.

According to a seventh aspect, a chip is provided. The chip includes a processor and a communication interface, the communication interface is coupled to the processor, and the processor is configured to run a program or an instruction to implement the method according to the first aspect.

According to an eighth aspect, a computer program/program product is provided. The computer program/program product is stored in a storage medium, and the computer program/program product is executed by at least one processor to implement the steps of the measurement method according to the first aspect.

According to a ninth aspect, a communication device is provided, configured to perform the steps of the measurement method according to the first aspect.

In the embodiments of this application, the terminal controls RRM measurement according to the measurement performance of the first object, for example, performs measurement on an NCD SSB of a present cell or performs measurement on a CD SSB of a present cell. In this way, not all terminals perform measurement on a CD SSB, so that impact of a large quantity of RedCap terminals on a normal terminal (measurement on the CD SSB on the first BWP) can be avoided.

### BRIEF DESCRIPTION OF DRAWINGS

FIG. 1 is a block diagram of a wireless communication system to which the embodiments of this application can be applied;

FIG. 2A to FIG. 2D are schematic diagrams of locations of a CD SSB and an NCD SSB;

FIG. 3 is a schematic flowchart of a measurement method according to an embodiment of this application;

FIG. 4 is a schematic structural diagram of a measurement apparatus according to an embodiment of this application;

FIG. 5 is a schematic structural diagram of a communication device according to an embodiment of this application; and

FIG. 6 is a schematic structural diagram of a terminal according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In the specification and claims of this application, the terms “first,” “second,” and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, in the specification and claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions. These technologies can also be applied to applications other than an NR system application, such as a 6th Generation (6G) communication system.

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home (a home device with a wireless communication function, such as a refrigerator, a television, a washing machine, or a furniture), a game console, a Personal Computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a specific type of the terminal 11 is not limited in the embodiments of this application. The network side device 12 may include an access network device or a core network device. The access network device 12 may also be referred to as a radio access network device, a Radio Access Network (RAN), a radio access network function, or a radio access network unit. The access network device 12 may include a base station, a Wireless Local Area Network (WLAN) access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home eNB, a Transmission and Reception Point (TRP), or another appropriate term in the field. As long as a same technical effect is achieved, the base station is not limited to a specified technical term. It should be noted that, in this application, only a base station in an NR system is used as an example, and a specific type of the base station is not limited.

In NR, a terminal performs one or more of the following operations on an initial downlink bandwidth part (initial DL BWP, also referred to as a first downlink bandwidth part) of a cell: receiving of a synchronization signal block, uplink sending (in a corresponding initial uplink BWP, initial UL BWP) or downlink receiving of a random access process, receiving of system information, and receiving of paging information. The terminal performs RRM measurement and cell reselection determining based on a cell defining synchronization signal block (cell defining SSB, CD SSB, also referred to as a first SSB in this specification) in the initial downlink BWP.

A separate initial DL BWP (also referred to as a second downlink BWP in this specification) is configured for some terminals (for example, some types of terminals, such as a function-limited terminal (RedCap UE)). The terminal may perform the foregoing sending and receiving behavior in the separate BWP. The separate BWP and the first downlink BWP may be staggered, partially overlapped, or have an inclusive relationship in frequency domain. The terminal needs to obtain downlink synchronization, measurement, Automatic Gain Control (AGC), and the like based on an SSB. If the separate initial DL BWP does not include an SSB, the terminal may need to frequently perform RF retuning, that is, the terminal needs to frequently return from the separate initial DL BWP to bandwidth of the first downlink BWP for SSB reception. Consequently, power consumption of the terminal increases, a service interruption probability increases, system performance decreases, and the like. Therefore, the second downlink BWP includes one SSB (also referred to as a second SSB in this specification, where the second SSB is an NCD SSB), so that power consumption for sending and receiving by the terminal on the BWP can be reduced. The second SSB is generally an NCD SSB, that is, the SSB does not include a configuration indication of receiving of system information.

The terminal may determine a location and a frequency of the second SSB in the second downlink BWP according to system information in the first downlink BWP or higher layer signaling, and the terminal performs RRM measurement at the frequency of the second SSB. The measurement may be intra-frequency measurement, including measurement on a serving cell and measurement on an intra-frequency neighboring cell. According to a measurement result, it is determined whether measurement on a neighboring cell is enabled or whether reselection of a neighboring cell is performed at the frequency.

Before performing intra-frequency measurement and inter-frequency measurement, the terminal first performs measurement on a serving cell. When a measurement result of the serving cell (including Reference Signal Received Power (RSRP) and/or Reference Signal Received Quality (RSRQ)) is greater than a threshold, the terminal may not perform intra-frequency or inter-frequency measurement.

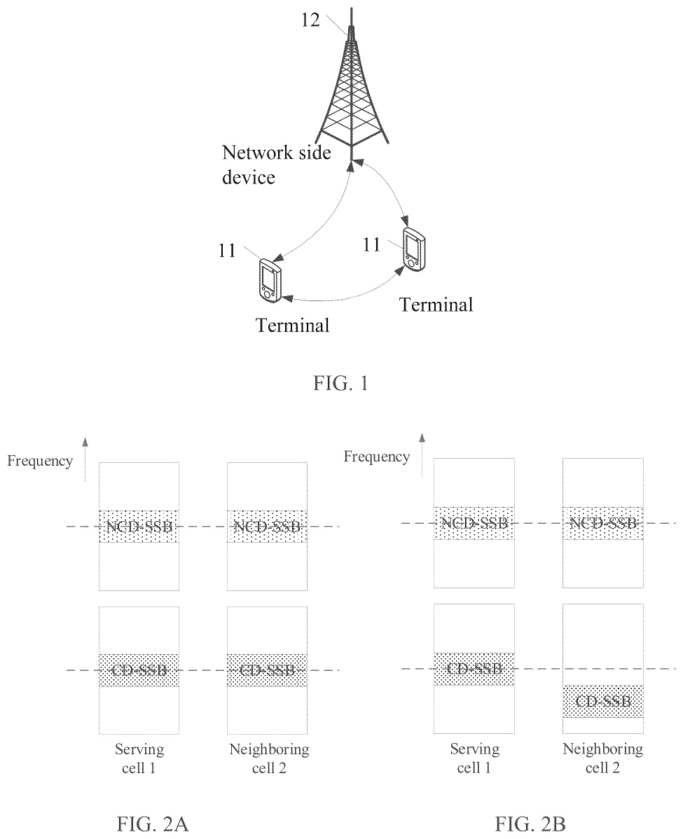

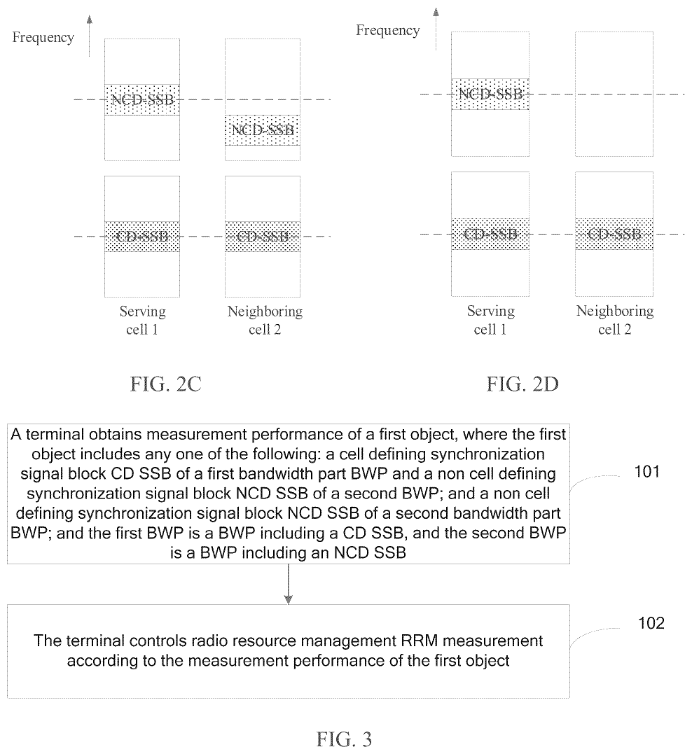

As shown in FIG. 2A to FIG. 2D, deployment locations of a CD SSB and an NCD SSB are flexible in the network, and deployment of a neighboring cell does not necessarily exist at a frequency of the CD SSB or the NCD SSB. As shown in FIG. 2A, frequency locations of CD SSBs and NCD SSBs of two cells are the same. As shown in FIG. 2B, frequencies of NCD SSBs of two cells are the same, but frequencies of CD SSBs are different. As shown in FIG. 2C and FIG. 2D, frequency locations of CD SSBs of two cells are the same, but frequency locations of NCD SSBs are different, or there is no NCD SSB in a second cell.

Physical Cell Identifier (PCI) of SSBs at different frequency locations of a same cell/carrier deployed in the network may be the same or different. Network deployment has relatively large flexibility, and the PCI is carried by using a synchronization signal in an SSB.

However, if PCIs of two different frequencies are different, as shown in FIG. 2A, even if the terminal knows a frequency location of a CD SSB of the second cell, the terminal cannot learn a PCI of a first SSB associated with a second SSB with better measured signal quality without indication of extra information. That is, the terminal does not know a PCI of a target reselection cell, and consequently, the terminal cannot quickly reselect and/or camp on a target cell.

In addition, timing of transmit powers and frames/slots/symbols of SSBs at different frequency locations may be different. In a case that the terminal does not know the information, the terminal may not perform accurate measurement or quickly complete cell reselection.

In NR, the network may deploy CD SSBs at some preset frequencies, and the terminal searches for a synchronization signal block at these frequencies.

An NCD SSB may be deployed at a frequency corresponding to a synchronization signal raster (sync raster) to be sent, or may be sent at a frequency of a non sync raster. When the NCD SSB is on the sync raster, information in a Physical Broadcast Channel (PBCH) indicates one of the following information:
there is no CD SSB within a preset frequency range; and
a frequency of a nearest CD SSB.

If the NCD SSB is deployed on the sync raster, this is not an optimized deployment, because the terminal may find the cell through searching and cannot directly obtain system information at the frequency to access the cell. Therefore, this deployment increases a delay for cell searching by the terminal.

A more optimized deployment is to deploy the NCD SSB at a frequency outside the sync raster. In this case, (partial) information indicated by a PBCH in the SSB is currently meaningless. Therefore, it may be considered that the terminal is assisted to determine measurement and reselection behavior by using the indication information of the PBCH in this deployment manner.

### Cell Selection and Reselection:

1. In an initial cell selection process (UE does not know in advance which Radio Frequency (RF) channel is a carrier of NR), the UE scans all RF channels (a scanning sequence is not specified in a protocol) one by one according to a capability of the UE, and searches for a suitable NR cell. At each scanned carrier frequency, the UE only needs to search for a cell with strongest signal quality. Once a suitable cell is found, the cell is selected for camping and the initial cell selection process is stopped, that is, an unscanned RF channel does not need to be scanned.

The suitable cell meets at least all the following conditions:
signal quality of the cell meets a preset condition, where the signal quality includes RSRP and/or RSRQ;
the UE may obtain necessary system information (including at least a Master Information Block (MIB) and a System Information Block1 (SIB1)); and
a cellbar Information Element (IE) in the system information (which may be set to barred and notBarred) is set to notBarred, that is, the cell is not prohibited to attach or access.

### 2. Cell Reselection Process

The UE sequentially evaluates whether each frequency has a suitable reselection target cell in descending order of frequency priorities provided by the network, and only a suitable cell can be used as the reselection target cell.

Different frequencies may be configured with a same frequency priority or different frequency priorities.

For example:

When the UE camps on a serving cell, if a cell at a frequency of NR or LTE with a higher priority meets cell signal quality Squal>threshold Thresh_{X, HighQ} within a period of time Treselection_{RAT}, or if a cell at a frequency of NR or another Radio Access Technology (RAT) with a higher priority meets signal strength Srxlev>threshold Thresh_{X, HighP} within a period of time Treselection_{RAT}, and the UE has camped on a current serving cell for more than one second, a reselection process is initiated to the cell at the frequency of NR or another RAT with a higher priority.

In LTE and NR systems, an idle state protocol defines a measurement related configuration and a measurement trigger condition of a neighboring cell in an idle state and an inactive state, and further defines a related measurement configuration and a measurement report condition in a connected state.

When it is determined whether to perform measurement on an intra-frequency neighboring cell for cell selection or reselection, if a serving cell meets Srxlev>SIntraSearchP and Squal>SIntraSearchQ, the UE does not select to perform measurement on the intra-frequency neighboring cell. Otherwise, if it is less than the threshold, the UE needs to perform measurement on the intra-frequency neighboring cell.

In inter-frequency and Inter-RAT scenarios, when a priority is greater than that of a serving frequency and an RAT, the terminal performs measurement on a neighboring cell according to a measurement requirement defined in the protocol. When the priority is equal to or less than that of the serving frequency and the RAT, and the serving cell meets Srxlev>SnonIntraSearchP and Squal>SnonIntraSearchQ, the UE selects not to perform measurement on the neighboring cell. Otherwise, if it is less than the threshold, the UE needs to perform measurement on the neighboring cell.

The foregoing measurement threshold of the neighboring cell is optional on the network side. When it is not configured, the threshold is defined in the protocol. When a measurement result of a present cell does not meet an S criterion for several consecutive times, measurement on the neighboring cell is triggered.

In a connected state, the terminal determines whether a measurement result (RSRP or RSRQ) of a Special Cell (SpCell) and a configured S-measure related threshold (s-MeasureConfig) meet the condition. If the measurement result is less than the configured threshold, the terminal calculates and reports the measurement result according to a measurement configuration and a measurement report configuration. Therefore, when the measurement result is greater than the threshold, corresponding measurement and measurement report do not need to be performed.

With reference to the accompanying drawings, the following describes in detail a measurement method provided in the embodiments of this application by using some embodiments and application scenarios thereof.

An embodiment of this application provides a measurement method. As shown in FIG. 3, the method includes:

Step 101: A terminal obtains measurement performance of a first object, where the first object includes any one of the following: a cell defining synchronization signal block CD SSB of a first bandwidth part BWP and a non cell defining synchronization signal block NCD SSB of a second BWP; and a non cell defining synchronization signal block NCD SSB of a second bandwidth part BWP; and the first BWP is a BWP including a CD SSB, and the second BWP is a BWP including an NCD SSB.

Step 102: The terminal controls radio resource management RRM measurement according to the measurement performance of the first object.

In this embodiment of this application, the terminal controls RRM measurement according to the measurement performance of the first object, for example, performs measurement on an NCD SSB of a present cell or performs measurement on a CD SSB of a present cell. In this way, not all terminals perform measurement on a CD SSB, so that impact of a large quantity of RedCap terminals on a normal terminal (measurement on the CD SSB on the first BWP) can be avoided. In addition, measurement by some terminals can be handed over to the second BWP, so that load balancing on a network side can be effectively performed, and impact on an existing terminal on the first BWP is reduced.

In this embodiment, the first BWP is an initial BWP, including a first SSB. The second BWP is a separate initial BWP, including a second SSB. The second BWP is different from the first BWP.

A BWP (including the first BWP and the second BWP) includes at least one of the following: an uplink UL BWP and a downlink DL BWP.

The first SSB is a CD SSB. APBCH in the CD SSB includes configuration information indicating receiving of system information, and/or a transmit frequency location of the CD SSB is in a frequency location corresponding to a Sync Raster. The second SSB is an NCD SSB. APBCH in the NCD SSB does not include configuration information indicating receiving of system information, and/or a transmit frequency location of the NCD SSB is not in a frequency location corresponding to a Sync Raster.

In some embodiments, the controlling RRM measurement includes at least one of the following:
not performing, by the terminal, measurement on a CD SSB of a present cell, or performing, by the terminal, measurement on a CD SSB of a present cell;
not performing, by the terminal, measurement on an NCD SSB of a present cell, or performing, by the terminal, measurement on an NCD SSB of a present cell;
not performing, by the terminal, measurement on an intra-frequency neighboring cell, or performing, by the terminal, measurement on an intra-frequency neighboring cell; and not performing, by the terminal, measurement on an inter-frequency or inter-system neighboring cell, or performing, by the terminal, measurement on an inter-frequency or inter-system neighboring cell. The inter-frequency or inter-system neighboring cell includes at least one of the following: an inter-frequency or inter-system neighboring cell of a low priority frequency, an inter-frequency or inter-system neighboring cell of a same priority frequency, and an inter-frequency or inter-system neighboring cell of a high priority frequency.

In this embodiment, in some embodiments, the controlling, by the terminal, RRM measurement according to the measurement performance of the first object includes any one of the following:
controlling RRM measurement according to measurement performance of the CD SSB of the first BWP;
controlling RRM measurement according to measurement performance of the CD SSB of the first BWP and measurement performance of the NCD SSB of the second BWP;
controlling RRM measurement according to measurement performance of the NCD SSB of the second BWP; and
controlling RRM measurement according to measurement performance of an SSB of a current BWP, where the current BWP is a BWP used for performing any one of the following operations: monitoring an SSB, receiving system information SI, receiving a paging message, monitoring an advance indication signal, executing random access RACH, and performing camping.

Before the obtaining, by a terminal, measurement performance of a first object, the method further includes:
receiving, by the terminal, configuration information of the NCD SSB of the second BWP from a network side device. In this way, after receiving the configuration information of the NCD SSB, the terminal measures the NCD SSB by using the configuration information. Subsequent behavior on the second BWP needs to be completed by measuring the NCD SSB.

In some embodiments, the obtaining, by a terminal, measurement performance of a first object includes:
performing, by the terminal, measurement according to the configuration information to obtain the measurement performance of the first object.

In some embodiments, before the controlling, by the terminal, radio resource management RRM measurement according to the measurement performance of the first object, the method further includes:
controlling, by the terminal, RRM measurement according to measurement performance of the CD SSB of the first BWP. In this way, the NCD SSB is measured on the second BWP after the CD SSB is measured on the first BWP, so that it can be ensured that RRM measurement can be successfully performed. Even if the NCD SSB is not successfully measured on the second BWP, the CD SSB has been measured on the first BWP.

In some embodiments, the controlling, by the terminal, RRM measurement according to the measurement performance of the first object includes:
controlling RRM measurement according to the measurement performance of the first object in a case that the terminal meets a first preset condition, where
the first preset condition includes at least one of the following:
the terminal receives system information SI, or receives a paging message, or monitors an advance indication signal, or executes random access, or performs camping on a second BWP of a present cell (that is, the terminal camps on the second BWP), so that frequent handover of the terminal between the second BWP and the first IBWP can be avoided;
a present cell is configured with an NCD SSB, so that frequent handover of the terminal between the second BWP and the first IBWP can be avoided;
a neighboring cell is configured with an NCD SSB, so that frequent handover of the terminal between the second BWP and the first IBWP can be avoided;
a random access-related configuration is configured on a second BWP of a present cell and/or a neighboring cell, so that frequent handover of the terminal between the second BWP and the first IBWP can be avoided, where the random access-related configuration is a configuration corresponding to random access, such as a preamble, an RACH resource, and an RACH Occasion (RO);
an S-Measure criterion is met, where for example, a condition for meeting the S-Measure criterion may be: measurement performance of a present cell is greater than a preset threshold, so that only the terminal in a cell center controls RRM measurement according to the measurement performance of the first object, and a scenario in which measurement on an NCD SSB is used to control RRM measurement can be limited, thereby avoiding possible degradation of mobility performance;
cell measurement performance is determined according to measurement performance of the NCD SSB of the second BWP, or measurement performance of the NCD SSB of the second BWP can represent cell measurement performance, or measurement performance of the NCD SSB of the second BWP can replace measurement performance of the CD SSB of the first BWP, so that frequent handover of the terminal between the second BWP and the first IBWP can be avoided; and
network indication information is received, where the network indication information is used to configure any one of the following: performing a cell selection or reselection operation according to measurement performance of the NCD SSB of the second BWP; performing a cell selection or reselection operation according to measurement performance of the NCD SSB of the second BWP and measurement performance of the CD SSB of the first BWP; an R criterion according to measurement performance of the NCD SSB of the second BWP; an S criterion according to measurement performance of the NCD SSB of the second BWP; and one of the foregoing preset conditions, so that frequent handover of the terminal between the second BWP and the first IBWP can be avoided.

In this embodiment, RRM measurement is controlled according to the measurement performance of the first object in a case that the first preset condition is met, so that a scenario in which measurement on an NCD SSB is used to control RRM measurement can be limited, thereby avoiding possible degradation of mobility performance.

In some embodiments, in a case that the terminal is in a connected state, the network indication information is sent by using a Radio Resource Control (RRC) message; or in a case that the terminal is in an idle state or an inactive state, the network indication information is sent by using at least one of the following messages: a broadcast system message, a paging message, a paging advance indication message, and a dedicated RRC message, where the paging message includes Downlink Control Information (DCI) corresponding to a Physical Downlink Shared Channel (PDSCH) and/or a Physical Downlink Control Channel (PDCCH), and the dedicated RRC message includes an RRC release message, an RRC suspend message, an RRC reject message, and the like.

In some embodiments, the first preset condition may further include at least one of the following:

When receiving the configuration information of the NCD SSB of the second BWP from a first network side device, the terminal performs a predetermined operation on the second BWP, or is handed over from the first BWP to the second BWP. In this way, some terminals or terminal behavior is handed over to the second BWP, so that load balancing on a network side can be effectively performed, or impact on an existing terminal on the first BWP is reduced.

Bandwidth of the first BWP exceeds bandwidth of the terminal, where the bandwidth of the terminal includes at least one of the following: bandwidth supported by the terminal, channel bandwidth of the terminal, and BWP bandwidth supported by the terminal; and the bandwidth of the first BWP includes at least one of the following: bandwidth or minimum bandwidth or maximum bandwidth configured by the first BWP, system bandwidth configured by the first BWP, and channel bandwidth configured by the first BWP. In this way, a case that the terminal cannot access a network can be avoided.

Carrier bandwidth, channel bandwidth, or system bandwidth exceeds bandwidth of the terminal, where the bandwidth of the terminal includes at least one of the following: bandwidth supported by the terminal, channel bandwidth of the terminal, and BWP bandwidth supported by the terminal; and the carrier bandwidth or the channel bandwidth or the system bandwidth is configured by the network side device or stipulated in a protocol. In this way, a case that the terminal cannot access a network can be avoided.

Bandwidth of the second BWP is less than or equal to bandwidth of the terminal, where the bandwidth of the terminal includes at least one of the following: bandwidth supported by the terminal, channel bandwidth of the terminal, and BWP bandwidth supported by the terminal; and the bandwidth of the second BWP includes at least one of the following: bandwidth or minimum bandwidth or maximum bandwidth configured by the second BWP, system bandwidth configured by the second BWP, and channel bandwidth configured by the second BWP. In this way, some terminals or terminal behavior can be handed over to the second BWP, so that load balancing on a network side can be effectively performed, or impact on an existing terminal on the first BWP is reduced.

Measurement performance of the first BWP is less than or equal to a twenty-first preset threshold, where the twenty-first preset threshold may be configured by the network side device or stipulated in a protocol. Therefore, when quality of the first BWP is poor, handover to the second BWP can be implemented to perform a predetermined operation or handover to the second BWP is performed, thereby ensuring system performance. The measurement performance of the first BWP is measurement performance of a reference signal (CD SSB) on the first BWP. In this way, performance of corresponding behavior of the terminal on the second BWP can be effectively ensured, so that the measurement performance of the first BWP is not too low to affect performance of the terminal.

Measurement performance of the second BWP is greater than or equal to a twenty-second preset threshold, where the twenty-second preset threshold may be configured by the network side device or stipulated in a protocol. Therefore, when quality of the second BWP is good, handover to the second BWP can be implemented to perform a predetermined operation or handover to the second BWP is performed, so that load balancing on a network side can be effectively performed, or impact on an existing terminal on the first BWP is reduced, thereby ensuring system performance. The measurement performance of the second BWP is measurement performance of a reference signal (NCD SSB) on the second BWP.

Measurement performance of the terminal in a present cell is greater than a twenty-third preset threshold, where the twenty-third preset threshold may be configured by the network side device or stipulated in a protocol. Therefore, when channel quality of the present cell is good, handover to the second BWP can be implemented to perform a predetermined operation or handover to the second BWP is performed, and some terminals or terminal behavior is handed over to the second BWP. In this way, load balancing on a network side can be effectively performed, or impact on an existing terminal on the first BWP can be reduced, thereby ensuring system performance.

Measurement performance of the terminal in a neighboring cell is less than a twenty-fourth preset threshold, where the twenty-fourth preset threshold may be configured by the network side device or stipulated in a protocol. Therefore, when channel quality of the neighboring cell is poor, handover to the second BWP can be implemented to perform a predetermined operation or handover to the second BWP is performed, thereby ensuring system performance. The neighboring cell includes at least one of the following: an intra-frequency neighboring cell, an inter-frequency neighboring cell, and an inter-system neighboring cell. That is, in a case that the measurement performance of the neighboring cell is not good enough, some terminals or terminal behavior is handed over to the second BWP, so that load balancing on a network side can be effectively performed, or impact on an existing terminal on the first BWP can be reduced.

The terminal is in a cell center or is not at a cell edge. Therefore, when the terminal is close to or is in the cell center, handover to the second BWP can be implemented to perform a predetermined operation or handover to the second BWP is performed, so that load balancing can be implemented on a network side, or impact on an existing terminal on the first BWP is reduced.

The terminal meets an S-measure mechanism, so that some terminals or terminal behavior is handed over to the second BWP, so that load balancing on a network side can be effectively performed, or impact on an existing terminal on the first BWP is reduced.

The terminal does not enable measurement on a neighboring cell, where the neighboring cell includes at least one of the following: an intra-frequency neighboring cell, an inter-frequency neighboring cell, and an inter-system neighboring cell. In this way, some terminals or terminal behavior is handed over to the second BWP, so that load balancing on a network side can be effectively performed, or impact on an existing terminal on the first BWP is reduced.

A second network side device sends an NCD SSB on the second BWP, where the second network side device is a network side device corresponding to a neighboring cell, and the neighboring cell herein includes some neighboring cells and all neighboring cells; and the terminal may receive the NCD SSB sent by the second network side device, or may receive a message indicating that the second network side device sends the NCD SSB on the second BWP.

The terminal performs cell selection or reselection. Therefore, some terminals or terminal behavior is handed over to the second BWP, so that load balancing on a network side can be effectively performed, or impact on an existing terminal on the first BWP is reduced.

The terminal is in a low mobility or still state. Therefore, some terminals or terminal behavior is handed over to the second BWP, so that load balancing on a network side can be effectively performed, or impact on an existing terminal on the first BWP is reduced.

A random number corresponding to the terminal falls within a preset range, that is, terminals of a preset proportion perform a predetermined operation on the second BWP or are handed over from the first BWP to the second BWP, so that load balancing can be implemented on a network side. The preset range is a range determined by using the preset proportion. If the preset proportion is X % terminals, a corresponding terminal generates a random number ranging from 0 to 1. If the random number is less than or equal to X %, the random number corresponding to the terminal falls within the preset range. If the random number generated by the terminal is greater than or equal to X %, the random number corresponding to the terminal does not fall within the preset range, that is, load control is implemented on the network side in a specified proportion.

The second BWP has a specific reference signal, where the specific reference signal includes an NCD SSB. For example, when the second BWP has a reference signal such as an SSB, a Channel State Information Resource Indicator (CSI-RS), a Sounding Reference Signal (SRS), or a Demodulation Reference Signal (DMRS), some terminals or terminal behavior is handed over to the second BWP, so that load balancing on a network side can be effectively performed, or impact on an existing terminal on the first BWP can be reduced.

A first indication of a first network side device is received.

In some embodiments, the method further includes:
receiving a third indication of a first network side device, where the third indication is used to indicate the first preset condition. After receiving the third indication from the first network side device, the terminal performs a predetermined operation or is handed over from the first BWP to the second BWP. The first network side device may deliver the third indication according to system load, to instruct the terminal to perform a predetermined operation on the second BWP to implement load balancing. In addition, the first network side device may further deliver the third indication to a RedCap terminal, to avoid impact of a large quantity of RedCap terminals on a normal terminal (a terminal that performs a predetermined operation on the first BWP).

In some embodiments, the first indication is used to indicate at least one of the following:

The terminal performs the predetermined operation on the second BWP or is handed over from the first BWP to the second BWP.

The second BWP can be used to perform the predetermined operation or can be handed over from the first BWP to the second BWP.

Load of a present cell or the first BWP is greater than a twenty-fifth preset threshold, where the twenty-fifth preset threshold may be configured by the network side device or stipulated in a protocol. Therefore, when the load of the first BWP or the present cell is high, handover to the second BWP can be implemented to perform a predetermined operation or handover to the second BWP is performed, thereby implementing load balancing. The present cell or the first BWP does not support the terminal type. In this case, to ensure that the terminal can access the present cell, the terminal is handed over to the second BWP to perform a predetermined operation or is handed over to the second BWP, so that execution of the predetermined operation can be ensured. The terminal type may include a RedCap terminal, a terminal with one single receive antenna, and a narrowband terminal. The terminal performs cell selection or reselection according to measurement performance of the NCD SSB of the second BWP.

The terminal performs cell selection or reselection according to measurement performance of the NCD SSB of the second BWP and measurement performance of the cell defining synchronization signal block CD SSB of the first BWP.

The terminal meets an R criterion according to measurement performance of the NCD SSB of the second BWP.

The terminal meets an S criterion according to measurement performance of the NCD SSB of the second BWP.

Measurement performance of a present cell is determined according to measurement performance of the NCD SSB of the second BWP, or measurement performance of the NCD SSB of the second BWP can represent measurement performance of a present cell, or measurement performance of the NCD SSB of the second BWP can replace measurement performance of the CD SSB of the first BWP.

It should be noted that the R criterion for cell reselection is to sort measurement performance of a neighboring cell or measurement performance of a present cell and a neighboring cell, and select a cell with best measurement performance as a target cell. Herein, the measurement performance of the NCD SSB of the second BWP is used as measurement performance of a corresponding cell.

The S criterion for cell selection and reselection may include: measurement performance of a target cell is greater than a preset threshold 1; or measurement performance of a target cell is greater than a preset threshold 1, and measurement performance of a present cell is less than a preset threshold 2. The preset threshold 1 and the preset threshold 2 may be determined based on an actual requirement. Herein, the measurement performance of the NCD SSB of the second BWP is used as measurement performance of a corresponding cell.

In some embodiments, that the terminal is in a low mobility or still state includes at least one of the following:
a measurement performance variation of the terminal in a present cell is less than a twenty-sixth preset threshold or a first reference threshold, where the first reference threshold is a reference threshold of a serving cell;
a beam measurement variation of the terminal in a present cell is less than a twenty-seventh preset threshold or a second reference threshold, where the second reference threshold is a reference threshold of a serving cell; and
q quantity of beams whose beam measurement variation of the terminal in a present cell is greater than a twenty-seventh preset threshold is less than a twenty-eighth preset threshold, where
the twenty-sixth preset threshold, the twenty-seventh preset threshold, and the twenty-eighth preset threshold may be configured by the network side device or stipulated in a protocol.

In some embodiments, in a case that the terminal is in a connected state, the first indication is sent by using a radio resource control RRC message; or
in a case that the terminal is in an idle state or an inactive state, the first indication is sent by using at least one of the following messages: a broadcast system message, a paging message, a paging advance indication message, and a dedicated RRC message, where the paging message includes downlink control information DCI corresponding to a PDSCH and/or a PDCCH, and the dedicated RRC message includes an RRC release message, an RRC suspend message, an RRC reject message, and the like.

In some embodiments, the controlling RRM measurement according to the measurement performance of the first object in a case that the terminal meets a first preset condition includes:
in a case that the terminal meets the first preset condition, controlling RRM measurement according to the measurement performance of the NCD SSB of the second BWP; and/or controlling RRM measurement on an NCD SSB of a second BWP of an intra-frequency or inter-frequency or inter-system neighboring cell according to the measurement performance of the NCD SSB of the second BWP.

In some embodiments, the controlling RRM measurement according to measurement performance of the NCD SSB of the second BWP includes:
in a case that measurement performance of an NCD SSB of a second BWP of a present cell is greater than or equal to a first preset threshold, performing, by the terminal, at least one of the following: the terminal does not perform measurement on an intra-frequency neighboring cell, the terminal does not perform measurement on an inter-frequency or inter-system neighboring cell, and the terminal does not perform measurement on a CD SSB of the present cell, so that measurement on a neighboring cell can be reduced, thereby achieving power saving; or
in a case that measurement performance of an NCD SSB of a second BWP of a present cell is less than or equal to a second preset threshold, performing, by the terminal, at least one of the following: the terminal performs measurement on an intra-frequency neighboring cell, the terminal performs measurement on an inter-frequency or inter-system neighboring cell, and the terminal performs measurement on a CD SSB of the present cell, so that measurement on a neighboring cell can be reduced, thereby achieving power saving; and frequent handover of the terminal between the first BWP and the second BWP can be avoided, thereby ensuring mobility performance of the terminal as much as possible.

That the terminal does not perform measurement on an intra-frequency neighboring cell includes: the terminal does not perform measurement on an NCD SSB of a second BWP of the intra-frequency neighboring cell, and/or the terminal does not perform measurement on a CD SSB of a first BWP of the intra-frequency neighboring cell.

That the terminal does not perform measurement on an inter-frequency or inter-system neighboring cell includes: the terminal does not perform measurement on an NCD SSB of a second BWP of the inter-frequency or inter-system neighboring cell, and/or the terminal does not perform measurement on a CD SSB of a first BWP of the inter-frequency or inter-system neighboring cell.

That the terminal performs measurement on an intra-frequency neighboring cell includes: the terminal performs measurement on an NCD SSB of a second BWP of the intra-frequency neighboring cell, and/or the terminal performs measurement on a CD SSB of a first BWP of the intra-frequency neighboring cell.

That the terminal performs measurement on an inter-frequency or inter-system neighboring cell includes: the terminal performs measurement on an NCD SSB of a second BWP of the inter-frequency or inter-system neighboring cell, and/or the terminal performs measurement on a CD SSB of a first BWP of the inter-frequency or inter-system neighboring cell.

In some embodiments, the controlling RRM measurement according to measurement performance of the CD SSB of the first BWP and measurement performance of the NCD SSB of the second BWP includes:
in a case that measurement performance of an NCD SSB of a second BWP of a present cell is greater than or equal to a third preset threshold and measurement performance of a CD SSB of a first BWP is greater than or equal to an eleventh preset threshold, performing, by the terminal, at least one of the following: the terminal does not perform measurement on an intra-frequency neighboring cell, and the terminal does not perform measurement on an inter-frequency or inter-system neighboring cell, so that measurement on a neighboring cell can be reduced, thereby achieving power saving, where that the terminal does not perform measurement on an intra-frequency neighboring cell includes: the terminal does not perform measurement on an NCD SSB of a second BWP of the intra-frequency neighboring cell, and/or the terminal does not perform measurement on a CD SSB of a first BWP of the intra-frequency neighboring cell; and that the terminal does not perform measurement on an inter-frequency or inter-system neighboring cell includes: the terminal does not perform measurement on an NCD SSB of a second BWP of the inter-frequency or inter-system neighboring cell, and/or the terminal does not perform measurement on a CD SSB of a first BWP of the inter-frequency or inter-system neighboring cell; or
in a case that measurement performance of an NCD SSB of a second BWP of a present cell is greater than or equal to a fourth preset threshold and measurement performance of a CD SSB of a first BWP is less than or equal to a twelfth preset threshold, performing, by the terminal, at least one of the following: the terminal does not perform measurement on an intra-frequency neighboring cell, the terminal does not perform measurement on an inter-frequency or inter-system neighboring cell, the terminal performs measurement on an intra-frequency neighboring cell, and the terminal performs measurement on an inter-frequency or inter-system neighboring cell, so that measurement on a neighboring cell can be reduced, thereby achieving power saving, where that the terminal does not perform measurement on an intra-frequency neighboring cell includes: the terminal does not perform measurement on an NCD SSB of a second BWP of the intra-frequency neighboring cell; that the terminal does not perform measurement on an inter-frequency or inter-system neighboring cell includes: the terminal does not perform measurement on an NCD SSB of a second BWP of the inter-frequency or inter-system neighboring cell; that the terminal performs measurement on an intra-frequency neighboring cell includes: the terminal performs measurement on a CD SSB of a first BWP of the intra-frequency neighboring cell; and that the terminal performs measurement on an inter-frequency or inter-system neighboring cell includes: the terminal performs measurement on a CD SSB of a first BWP of the inter-frequency or inter-system neighboring cell; or
in a case that measurement performance of an NCD SSB of a second BWP of a present cell is less than or equal to a fifth preset threshold and measurement performance of a CD SSB of a first BWP is greater than or equal to a thirteenth preset threshold, performing, by the terminal, at least one of the following: the terminal performs measurement on an intra-frequency neighboring cell, the terminal performs measurement on an inter-frequency or inter-system neighboring cell, the terminal does not perform measurement on an intra-frequency neighboring cell, and the terminal does not perform measurement on an inter-frequency or inter-system neighboring cell, where that the terminal performs measurement on an intra-frequency neighboring cell includes: the terminal performs measurement on an NCD SSB of a second BWP of the intra-frequency neighboring cell; that the terminal performs measurement on an inter-frequency or inter-system neighboring cell includes: the terminal performs measurement on an NCD SSB of a second BWP of the inter-frequency or inter-system neighboring cell; that the terminal does not perform measurement on an intra-frequency neighboring cell includes: the terminal does not perform measurement on a CD SSB of a first BWP of the intra-frequency neighboring cell; and that the terminal does not perform measurement on an inter-frequency or inter-system neighboring cell includes: the terminal does not perform measurement on a CD SSB of a first BWP of the inter-frequency or inter-system neighboring cell; or
in a case that measurement performance of an NCD SSB of a second BWP of a present cell is less than or equal to a sixth preset threshold and measurement performance of a CD SSB of a first BWP is less than or equal to a fourteenth preset threshold, performing, by the terminal, at least one of the following: the terminal performs measurement on an intra-frequency neighboring cell, and the terminal performs measurement on an inter-frequency or inter-system neighboring cell, where that the terminal performs measurement on an intra-frequency neighboring cell includes: the terminal performs measurement on an NCD SSB of a second BWP of the intra-frequency neighboring cell, and/or the terminal performs measurement on a CD SSB of a first BWP of the intra-frequency neighboring cell; and that the terminal performs measurement on an inter-frequency or inter-system neighboring cell includes: the terminal performs measurement on an NCD SSB of a second BWP of the inter-frequency or inter-system neighboring cell, and/or the terminal performs measurement on a CD SSB of a first BWP of the inter-frequency or inter-system neighboring cell.

In some embodiments, the controlling RRM measurement according to measurement performance of an SSB of a current BWP includes:
in a case that the measurement performance of the SSB of the current BWP is greater than or equal to a seventh preset threshold, performing, by the terminal, at least one of the following: the terminal does not perform measurement on an intra-frequency neighboring cell, the terminal does not perform measurement on an inter-frequency or inter-system neighboring cell, and the terminal does not perform measurement on a CD SSB of a present cell, so that measurement on a neighboring cell can be reduced, thereby achieving power saving, where that the terminal does not perform measurement on an intra-frequency neighboring cell includes: the terminal does not perform measurement on an NCD SSB of a second BWP of the intra-frequency neighboring cell, and/or the terminal does not perform measurement on a CD SSB of a first BWP of the intra-frequency neighboring cell; and that the terminal does not perform measurement on an inter-frequency or inter-system neighboring cell includes: the terminal does not perform measurement on an NCD SSB of a second BWP of the inter-frequency or inter-system neighboring cell, and/or the terminal does not perform measurement on a CD SSB of a first BWP of the inter-frequency or inter-system neighboring cell; or
in a case that the measurement performance of the SSB of the current BWP is less than or equal to an eighth preset threshold, performing, by the terminal, at least one of the following: the terminal performs measurement on an intra-frequency neighboring cell, the terminal performs measurement on an inter-frequency or inter-system neighboring cell, and the terminal performs measurement on a CD SSB of a present cell, where that the terminal performs measurement on an intra-frequency neighboring cell includes: the terminal performs measurement on an NCD SSB of a second BWP of the intra-frequency neighboring cell, and/or the terminal performs measurement on a CD SSB of a first BWP of the intra-frequency neighboring cell; and that the terminal performs measurement on an inter-frequency or inter-system neighboring cell includes: the terminal performs measurement on an NCD SSB of a second BWP of the inter-frequency or inter-system neighboring cell, and/or the terminal performs measurement on a CD SSB of a first BWP of the inter-frequency or inter-system neighboring cell.

In some embodiments, the controlling RRM measurement according to measurement performance of the CD SSB of the first BWP includes:
in a case that measurement performance of a CD SSB of a first BWP of a present cell is greater than or equal to a ninth preset threshold, performing, by the terminal, at least one of the following: the terminal does not perform measurement on an intra-frequency neighboring cell, the terminal does not perform measurement on an inter-frequency or inter-system neighboring cell, and the terminal does not perform measurement on an NCD SSB of the present cell, where the terminal does not perform measurement on an intra-frequency neighboring cell includes: the terminal does not perform measurement on an NCD SSB of a second BWP of the intra-frequency neighboring cell, and/or the terminal does not perform measurement on a CD SSB of a first BWP of the intra-frequency neighboring cell; and that the terminal does not perform measurement on an inter-frequency or inter-system neighboring cell includes: the terminal does not perform measurement on an NCD SSB of a second BWP of the inter-frequency or inter-system neighboring cell, and/or the terminal does not perform measurement on a CD SSB of a first BWP of the inter-frequency or inter-system neighboring cell; or
in a case that measurement performance of a CD SSB of a first BWP of a present cell is less than or equal to a tenth preset threshold, performing, by the terminal, at least one of the following: the terminal performs measurement on an intra-frequency neighboring cell, the terminal performs measurement on an inter-frequency or inter-system neighboring cell, and the terminal performs measurement on an NCD SSB of the present cell, where that the terminal performs measurement on an intra-frequency neighboring cell includes: the terminal performs measurement on an NCD SSB of a second BWP of the intra-frequency neighboring cell, and/or the terminal performs measurement on a CD SSB of a first BWP of the intra-frequency neighboring cell; and that the terminal performs measurement on an inter-frequency or inter-system neighboring cell includes: the terminal performs measurement on an NCD SSB of a second BWP of the inter-frequency or inter-system neighboring cell, and/or the terminal performs measurement on a CD SSB of a first BWP of the inter-frequency or inter-system neighboring cell.

In the foregoing embodiment, when the terminal does not perform measurement on an intra-frequency neighboring cell, does not perform measurement on an inter-frequency or inter-system neighboring cell, or does not perform measurement on a CD SSB of a present cell, measurement on a neighboring cell can be reduced, thereby achieving power saving. When the terminal performs measurement on an intra-frequency neighboring cell, measurement on an inter-frequency or inter-system neighboring cell, and measurement on a CD SSB of a present cell, mobility performance of the terminal can be ensured as much as possible in consideration of a first purpose and a second purpose, where the first purpose is to reduce measurement on a neighboring cell, thereby achieving power saving; and the second purpose is to avoid frequent handover of the terminal between the first BWP and the second BWP.

When the terminal does not perform measurement on the NCD SSB of the second BWP, mobility impact of the terminal due to inaccurate measurement on the NCD SSB can be avoided.

In addition, in a case that the measurement performance of the NCD SSB of the second BWP of the present cell is greater than or equal to the fourth preset threshold and the measurement performance of the CD SSB of the first BWP is less than or equal to the twelfth preset threshold, to ensure mobility performance of the terminal, the terminal needs to perform CD-SSB measurement, so that mobility performance of the terminal is ensured.

The first preset threshold to the fourteenth preset threshold may be configured by the network side device or stipulated in a protocol. The NCD SSB and the CD SSB are a same preset threshold or different preset thresholds.

In some embodiments, the first preset threshold corresponding to the measurement performance of the NCD SSB is a sum of a threshold corresponding to S-Measure and a first preset offset, where the first preset offset is configured by the network side device or stipulated in a protocol; and/or the second preset threshold corresponding to the measurement performance of the NCD SSB is a sum of a threshold corresponding to S-Measure and a first preset offset, where the first preset offset is configured by the network side device or stipulated in a protocol.

In some embodiments, the third preset threshold corresponding to the measurement performance of the NCD SSB is a sum of a threshold corresponding to S-Measure and a third preset offset, where the third preset offset is configured by the network side device or stipulated in a protocol; and/or the fourth preset threshold corresponding to the measurement performance of the NCD SSB is a sum of a threshold corresponding to S-Measure and a fourth preset offset, where the fourth preset offset is configured by the network side device or stipulated in a protocol; and/or the fifth preset threshold corresponding to the measurement performance of the NCD SSB is a sum of a threshold corresponding to S-Measure and a fifth preset offset, where the fifth preset offset is configured by the network side device or stipulated in a protocol; and/or the sixth preset threshold corresponding to the measurement performance of the NCD SSB is a sum of a threshold corresponding to S-Measure and a sixth preset offset, where the sixth preset offset is configured by the network side device or stipulated in a protocol.

In some embodiments, the configuration information of the NCD SSB of the second BWP includes a configuration of the NCD SSB of the second BWP of the present cell and/or the neighboring cell, and may include at least one of the following:
transmit power information of the NCD SSB, including a transmit power of the NCD SSB and/or a transmit power difference between the NCD SSB and the CD SSB;
time domain information of the NCD SSB, including a time domain location of the NCD SSB and/or time synchronization information between the NCD SSB and the CD SSB;
frequency domain information of the NCD SSB, including a frequency domain location of the NCD SSB and/or a frequency domain location difference between the NCD SSB and the CD SSB;
a quasi-co-location relationship between the NCD SSB and the CD SSB; and
a measurement period and a length SMTC corresponding to the NCD SSB.

The measurement method provided in the embodiments of this application may be performed by a measurement apparatus. In the embodiments of this application, an example in which the measurement apparatus performs the measurement method is used as an example to describe the measurement apparatus provided in the embodiments of this application.

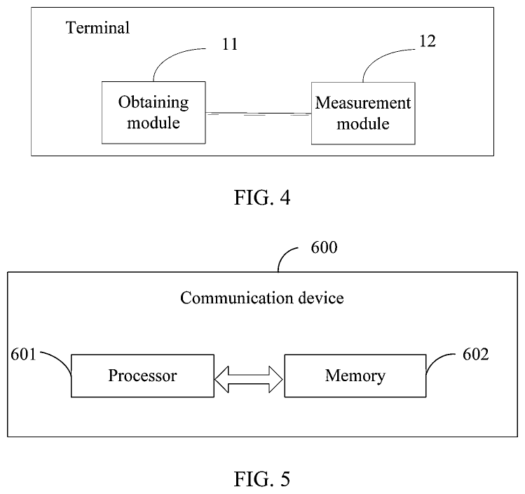

An embodiment of this application provides a measurement apparatus. As shown in FIG. 4, the apparatus includes:
an obtaining module 11, configured to obtain measurement performance of a first object, where the first object includes any one of the following: a cell defining synchronization signal block CD SSB of a first bandwidth part BWP and a non cell defining synchronization signal block NCD SSB of a second BWP; and a non cell defining synchronization signal block NCD SSB of a second bandwidth part BWP; and the first BWP is a BWP including a CD SSB, and the second BWP is a BWP including an NCD SSB; and
a measurement module 12, configured to control radio resource management RRM measurement according to the measurement performance of the first object.

In some embodiments, the obtaining module 11 is further configured to receive configuration information of the NCD SSB of the second BWP from a network side device.

In some embodiments, the obtaining module is configured to obtain measurement according to the configuration information to obtain the measurement performance of the first object.

In some embodiments, the measurement module is further configured to control RRM measurement according to measurement performance of the CD SSB of the first BWP.

In some embodiments, the measurement module is configured to perform any one of the following:
controlling RRM measurement according to measurement performance of the CD SSB of the first BWP;
controlling RRM measurement according to measurement performance of the CD SSB of the first BWP and measurement performance of the NCD SSB of the second BWP;
controlling RRM measurement according to measurement performance of the NCD SSB of the second BWP; and
controlling RRM measurement according to measurement performance of an SSB of a current BWP, where the current BWP is a BWP used for performing any one of the following operations: monitoring an SSB, receiving system information SI, receiving a paging message, monitoring an advance indication signal, executing random access RACH, and performing camping.

In some embodiments, the measurement module is configured to perform at least one of the following:
not perform measurement on a CD SSB of a present cell, or perform measurement on a CD SSB of a present cell;
not perform measurement on an NCD SSB of a present cell, or perform measurement on an NCD SSB of a present cell;
not perform measurement on an intra-frequency neighboring cell, or perform measurement on an intra-frequency neighboring cell; and
not perform measurement on an inter-frequency or inter-system neighboring cell, or perform measurement on an inter-frequency or inter-system neighboring cell.

In some embodiments, the measurement module is configured to control RRM measurement according to the measurement performance of the first object in a case that the terminal meets a first preset condition, where
the first preset condition includes at least one of the following:
the terminal receives system information SI, or receives a paging message, or monitors an advance indication signal, or executes random access, or performs camping on a second BWP of a present cell (that is, the terminal camps on the second BWP), so that frequent handover of the terminal between the second BWP and the first IBWP can be avoided;
a present cell is configured with an NCD SSB, so that frequent handover of the terminal between the second BWP and the first IBWP can be avoided;
a neighboring cell is configured with an NCD SSB, so that frequent handover of the terminal between the second BWP and the first IBWP can be avoided;
a random access-related configuration is configured on a second BWP of a present cell and/or a neighboring cell, so that frequent handover of the terminal between the second BWP and the first IBWP can be avoided, where the random access-related configuration is a configuration corresponding to random access, such as a preamble, an RACH resource, and an RO;
an S-Measure criterion is met, where for example, a condition for meeting the S-Measure criterion may be: measurement performance of a present cell is greater than a preset threshold, so that only the terminal in a cell center controls RRM measurement according to the measurement performance of the first object, and a scenario in which measurement on an NCD SSB is used to control RRM measurement can be limited, thereby avoiding possible degradation of mobility performance;
cell measurement performance is determined according to measurement performance of the NCD SSB of the second BWP, or measurement performance of the NCD SSB of the second BWP can represent cell measurement performance, or measurement performance of the NCD SSB of the second BWP can replace measurement performance of the CD SSB of the first BWP, so that frequent handover of the terminal between the second BWP and the first IBWP can be avoided; and
network indication information is received, where the network indication information is used to configure any one of the following: performing a cell selection or reselection operation according to measurement performance of the NCD SSB of the second BWP; performing a cell selection or reselection operation according to measurement performance of the NCD SSB of the second BWP and measurement performance of the CD SSB of the first BWP; an R criterion according to measurement performance of the NCD SSB of the second BWP; an S criterion according to measurement performance of the NCD SSB of the second BWP; and one of the foregoing preset conditions, so that frequent handover of the terminal between the second BWP and the first IBWP can be avoided.

In this embodiment, RRM measurement is controlled according to the measurement performance of the first object in a case that the first preset condition is met, so that a scenario in which measurement on an NCD SSB is used to control RRM measurement can be limited, thereby avoiding possible degradation of mobility performance.

In some embodiments, the measurement module is configured to: in a case that the terminal meets the first preset condition, control RRM measurement according to the measurement performance of the NCD SSB of the second BWP; and/or control RRM measurement on an NCD SSB of a second BWP of an intra-frequency or inter-frequency or inter-system neighboring cell according to the measurement performance of the NCD SSB of the second BWP.

In some embodiments, the measurement module is configured to: in a case that measurement performance of an NCD SSB of a second BWP of a present cell is greater than or equal to a first preset threshold, perform at least one of the following: not performing measurement on an intra-frequency neighboring cell, not performing measurement on an inter-frequency or inter-system neighboring cell, and not measurement on a CD SSB of the present cell; or in a case that measurement performance of an NCD SSB of a second BWP of a present cell is less than or equal to a second preset threshold, perform at least one of the following: performing measurement on an intra-frequency neighboring cell, performing measurement on an inter-frequency or inter-system neighboring cell, and performing measurement on a CD SSB of the present cell.

In some embodiments, the measurement module is configured to: in a case that measurement performance of an NCD SSB of a second BWP of a present cell is greater than or equal to a third preset threshold and measurement performance of a CD SSB of a first BWP is greater than or equal to an eleventh preset threshold, perform at least one of the following: not performing measurement on an intra-frequency neighboring cell, and not performing measurement on an inter-frequency or inter-system neighboring cell; or
in a case that measurement performance of an NCD SSB of a second BWP of a present cell is greater than or equal to a fourth preset threshold and measurement performance of a CD SSB of a first BWP is less than or equal to a twelfth preset threshold, perform at least one of the following: not performing measurement on an intra-frequency neighboring cell, not performing measurement on an inter-frequency or inter-system neighboring cell, performing measurement on an intra-frequency neighboring cell, and performing measurement on an inter-frequency or inter-system neighboring cell; or
in a case that measurement performance of an NCD SSB of a second BWP of a present cell is less than or equal to a fifth preset threshold and measurement performance of a CD SSB of a first BWP is greater than or equal to a thirteenth preset threshold, perform at least one of the following: performing measurement on an intra-frequency neighboring cell, performing measurement on an inter-frequency or inter-system neighboring cell, not performing measurement on an intra-frequency neighboring cell, and not performing measurement on an inter-frequency or inter-system neighboring cell; or
in a case that measurement performance of an NCD SSB of a second BWP of a present cell is less than or equal to a sixth preset threshold and measurement performance of a CD SSB of a first BWP is less than or equal to a fourteenth preset threshold, perform at least one of the following: performing measurement on an intra-frequency neighboring cell, and performing measurement on an inter-frequency or inter-system neighboring cell.

In some embodiments, the measurement module is configured to: in a case that the measurement performance of the SSB of the current BWP is greater than or equal to a seventh preset threshold, perform at least one of the following: not performing measurement on an intra-frequency neighboring cell, not performing measurement on an inter-frequency or inter-system neighboring cell, and not performing measurement on a CD SSB of a present cell; or
in a case that the measurement performance of the SSB of the current BWP is less than or equal to an eighth preset threshold, perform at least one of the following: performing measurement on an intra-frequency neighboring cell, performing measurement on an inter-frequency or inter-system neighboring cell, and performing measurement on a CD SSB of a present cell.

In some embodiments, the measurement module is configured to: in a case that measurement performance of a CD SSB of a first BWP of a present cell is greater than or equal to a ninth preset threshold, perform at least one of the following: not performing measurement on an intra-frequency neighboring cell, not performing measurement on an inter-frequency or inter-system neighboring cell, and not performing measurement on an NCD SSB of the present cell; or in a case that measurement performance of a CD SSB of a first BWP of a present cell is less than or equal to a tenth preset threshold, perform at least one of the following: performing measurement on an intra-frequency neighboring cell, performing measurement on an inter-frequency or inter-system neighboring cell, and performing measurement on an NCD SSB of the present cell.

In some embodiments, the measurement module is configured to perform at least one of the following:
not performing measurement on an NCD SSB of a second BWP of the intra-frequency neighboring cell; and
not performing measurement on a CD SSB of a first BWP of the intra-frequency neighboring cell; and/or
the measurement module is configured to perform at least one of the following:
not performing measurement on an NCD SSB of a second BWP of the inter-frequency or inter-system neighboring cell; and
not performing measurement on a CD SSB of a first BWP of the inter-frequency or inter-system neighboring cell; and/or
the measurement module is configured to perform at least one of the following:
performing measurement on an NCD SSB of a second BWP of the intra-frequency neighboring cell; and
performing measurement on a CD SSB of a first BWP of the intra-frequency neighboring cell; and/or
the measurement module is configured to perform at least one of the following:
performing measurement on an NCD SSB of a second BWP of the inter-frequency or inter-system neighboring cell; and
performing measurement on a CD SSB of a first BWP of the inter-frequency or inter-system neighboring cell.

In some embodiments, in a case that the measurement performance of the NCD SSB of the second BWP of the present cell is greater than or equal to the third preset threshold and the measurement performance of the CD SSB of the first BWP is greater than or equal to the eleventh preset threshold, the measurement module is configured to perform at least one of the following:
not performing measurement on an NCD SSB of a second BWP of the intra-frequency neighboring cell; and
not performing measurement on a CD SSB of a first BWP of the intra-frequency neighboring cell; and/or
the measurement module is configured to perform at least one of the following:
not performing measurement on an NCD SSB of a second BWP of the inter-frequency or inter-system neighboring cell; and
not performing measurement on a CD SSB of a first BWP of the inter-frequency or inter-system neighboring cell.

In some embodiments, in a case that the measurement performance of the NCD SSB of the second BWP of the present cell is greater than or equal to the fourth preset threshold and the measurement performance of the CD SSB of the first BWP is less than or equal to the twelfth preset threshold,
that the terminal does not perform measurement on an intra-frequency neighboring cell includes: the terminal does not perform measurement on an NCD SSB of a second BWP of the intra-frequency neighboring cell; and/or
that the terminal does not perform measurement on an inter-frequency or inter-system neighboring cell includes: the terminal does not perform measurement on an NCD SSB of a second BWP of the inter-frequency or inter-system neighboring cell; and/or
that the terminal performs measurement on an intra-frequency neighboring cell includes: the terminal performs measurement on a CD SSB of a first BWP of the intra-frequency neighboring cell; and/or
that the terminal performs measurement on an inter-frequency or inter-system neighboring cell includes: the terminal performs measurement on a CD SSB of a first BWP of the inter-frequency or inter-system neighboring cell.

In some embodiments, in a case that the measurement performance of the NCD SSB of the second BWP of the present cell is less than or equal to the fifth preset threshold and the measurement performance of the CD SSB of the first BWP is greater than or equal to the thirteenth preset threshold,
that the terminal performs measurement on an intra-frequency neighboring cell includes: the terminal performs measurement on an NCD SSB of a second BWP of the intra-frequency neighboring cell; and/or
that the terminal performs measurement on an inter-frequency or inter-system neighboring cell includes: the terminal performs measurement on an NCD SSB of a second BWP of the inter-frequency or inter-system neighboring cell; and/or
that the terminal does not perform measurement on an intra-frequency neighboring cell includes: the terminal does not perform measurement on a CD SSB of a first BWP of the intra-frequency neighboring cell; and/or
that the terminal does not perform measurement on an inter-frequency or inter-system neighboring cell includes: the terminal does not perform measurement on a CD SSB of a first BWP of the inter-frequency or inter-system neighboring cell.

In some embodiments, in a case that the measurement performance of the NCD SSB of the second BWP of the present cell is less than or equal to the sixth preset threshold and the measurement performance of the CD SSB of the first BWP is less than or equal to the fourteenth preset threshold,
that the terminal performs measurement on an intra-frequency neighboring cell includes at least one of the following: the terminal performs measurement on an NCD SSB of a second BWP of the intra-frequency neighboring cell, and the terminal does not perform measurement on a CD SSB of a first BWP of the intra-frequency neighboring cell; and/or
that the terminal performs measurement on an inter-frequency or inter-system neighboring cell includes at least one of the following: the terminal performs measurement on an NCD SSB of a second BWP of the inter-frequency or inter-system neighboring cell, and the terminal performs measurement on a CD SSB of a first BWP of the inter-frequency or inter-system neighboring cell.

In some embodiments, the first preset threshold corresponding to the measurement performance of the NCD SSB is a sum of a threshold corresponding to S-Measure and a first preset offset, where the first preset offset is configured by the network side device or stipulated in a protocol; and/or
the second preset threshold corresponding to the measurement performance of the NCD SSB is a sum of a threshold corresponding to S-Measure and a first preset offset, where the first preset offset is configured by the network side device or stipulated in a protocol.

In some embodiments, the third preset threshold corresponding to the measurement performance of the NCD SSB is a sum of a threshold corresponding to S-Measure and a third preset offset, where the third preset offset is configured by the network side device or stipulated in a protocol; and/or
the fourth preset threshold corresponding to the measurement performance of the NCD SSB is a sum of a threshold corresponding to S-Measure and a fourth preset offset, where the fourth preset offset is configured by the network side device or stipulated in a protocol; and/or
the fifth preset threshold corresponding to the measurement performance of the NCD SSB is a sum of a threshold corresponding to S-Measure and a fifth preset offset, where the fifth preset offset is configured by the network side device or stipulated in a protocol; and/or
the sixth preset threshold corresponding to the measurement performance of the NCD SSB is a sum of a threshold corresponding to S-Measure and a sixth preset offset, where the sixth preset offset is configured by the network side device or stipulated in a protocol.

In some embodiments, the first BWP includes at least one of the following:
an uplink BWP and a downlink BWP;
and/or
the second BWP includes at least one of the following:
an uplink BWP and a downlink BWP.

In some embodiments, a physical broadcast channel PBCH in the CD SSB includes configuration information indicating receiving of system information, and/or a transmit frequency location of the CD SSB is in a frequency location corresponding to a synchronization raster Sync Raster; and
a PBCH in the NCD SSB does not include configuration information indicating receiving of system information, and/or a transmit frequency location of the NCD SSB is not in a frequency location corresponding to a Sync Raster.

The measurement apparatus provided in this embodiment of this application can implement the processes implemented in the method embodiment in FIG. 3, and achieve a same technical effect. To avoid repetition, details are not described herein again.

For example, as shown in FIG. 5, an embodiment of this application further provides a communication device 600, including a processor 601 and a memory 602. The memory 602 stores a program or an instruction that can be run on the processor 601. When the communication device 600 is a terminal, the program or the instruction is executed by the processor 601 to implement the steps of the foregoing measurement method embodiment, and a same technical effect can be achieved. To avoid repetition, details are not described herein again.

An embodiment of this application further provides a terminal. The terminal includes a processor and a memory, the memory stores a program or an instruction that can be run on the processor, and the program or the instruction is executed by the processor to implement the steps of the foregoing measurement method.

An embodiment of this application further provides a terminal, including a processor and a communication interface. The processor is configured to obtain measurement performance of a first object, where the first object includes any one of the following: a cell defining synchronization signal block CD SSB of a first bandwidth part BWP and a non cell defining synchronization signal block NCD SSB of a second BWP; and a non cell defining synchronization signal block NCD SSB of a second bandwidth part BWP; and the first BWP is a BWP including a CD SSB, and the second BWP is a BWP including an NCD SSB; and control radio resource management RRM measurement according to the measurement performance of the first object.

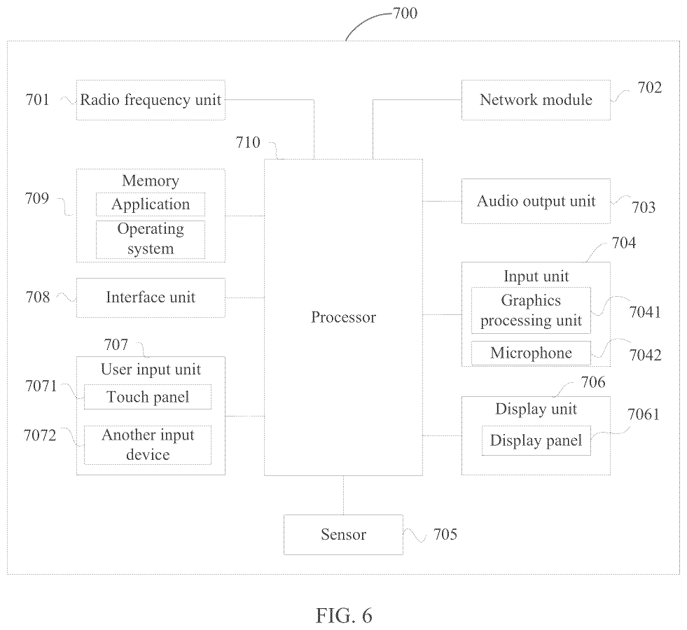

An embodiment of this application further provides a terminal, including a processor and a communication interface. This terminal embodiment corresponds to the foregoing method embodiment on the terminal side. Each implementation process and implementation of the foregoing method embodiment may be applicable to this terminal embodiment, and a same technical effect can be achieved. For example, FIG. 6 is a schematic structural diagram of hardware of a terminal according to an embodiment of this application.

A terminal 700 includes but is not limited to components such as a radio frequency unit 701, a network module 702, an audio output unit 703, an input unit 704, a sensor 705, a display unit 706, a user input unit 707, an interface unit 708, a memory 709, and a processor 710.

A person skilled in the art can understand that the terminal 700 may further include the power supply (for example, a battery) that supplies power to each component. The power supply may be logically connected to the processor 710 by using a power supply management system, so as to manage functions such as charging, discharging, and power consumption by using the power supply management system. The terminal structure shown in FIG. 6 constitutes no limitation on the terminal, and the terminal may include more or fewer components than those shown in the figure, or combine some components, or have different component arrangements. Details are not described herein.

It should be understood that, in this embodiment of this application, the input unit 704 may include a Graphics Processing Unit (GPU) 7041 and a microphone 7042, and the graphics processing unit 7041 processes image data of a still image or a video that is obtained by an image capturing apparatus (for example, a camera) in a video capturing mode or an image capturing mode. The display unit 706 may include a display panel 7061. The display panel 7061 may be configured in a form such as a liquid crystal display or an organic light-emitting diode. The user input unit 707 includes at least one of a touch panel 7071 and another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 701 may transmit the downlink data to the processor 710 for processing. In addition, the radio frequency unit 701 may send uplink data to the network side device. Usually, the radio frequency unit 701 includes but is not limited to an antenna, an amplifier, a transceiver, a coupler, a low noise amplifier, a duplexer, and the like.

The memory 709 may be configured to store a software program or an instruction and various data. The memory 709 may mainly include a first storage area for storing a program or an instruction and a second storage area for storing data. The first storage area may store an operating system, and an application or an instruction required by at least one function (for example, a sound playing function or an image playing function). In addition, the memory 709 may be a volatile memory or a non-volatile memory, or the memory 709 may include a volatile memory and a non-volatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 709 in this embodiment of this application includes but is not limited to these memories and a memory of any other proper type.

The processor 710 may include one or more processing units. In some embodiments, an application processor and a modem processor are integrated into the processor 710. The application processor mainly processes an operating system, a user interface, an application, and the like. The modem processor mainly processes a wireless communication signal, for example, a baseband processor. It can be understood that, alternatively, the modem processor may not be integrated into the processor 710.

In some embodiments, the processor 710 is configured to obtain measurement performance of a first object, where the first object includes any one of the following: a cell defining synchronization signal block CD SSB of a first bandwidth part BWP and a non cell defining synchronization signal block NCD SSB of a second BWP; and a non cell defining synchronization signal block NCD SSB of a second bandwidth part BWP; and the first BWP is a BWP including a CD SSB, and the second BWP is a BWP including an NCD SSB; and control radio resource management RRM measurement according to the measurement performance of the first object.

In some embodiments, the processor 710 is further configured to receive configuration information of the NCD SSB of the second BWP from a network side device.

In some embodiments, the processor 710 is configured to obtain measurement according to the configuration information to obtain the measurement performance of the first object.

In some embodiments, the processor 710 is further configured to control RRM measurement according to measurement performance of the CD SSB of the first BWP.

In some embodiments, the processor 710 is configured to perform any one of the following:
controlling RRM measurement according to measurement performance of the CD SSB of the first BWP;
controlling RRM measurement according to measurement performance of the CD SSB of the first BWP and measurement performance of the NCD SSB of the second BWP;
controlling RRM measurement according to measurement performance of the NCD SSB of the second BWP; and
controlling RRM measurement according to measurement performance of an SSB of a current BWP, where the current BWP is a BWP used for performing any one of the following operations: monitoring an SSB, receiving system information SI, receiving a paging message, monitoring an advance indication signal, executing random access RACH, and performing camping.

In some embodiments, the processor 710 is configured to perform at least one of the following:
not perform measurement on a CD SSB of a present cell, or perform measurement on a CD SSB of a present cell;
not perform measurement on an NCD SSB of a present cell, or perform measurement on an NCD SSB of a present cell;
not perform measurement on an intra-frequency neighboring cell, or perform measurement on an intra-frequency neighboring cell; and
not perform measurement on an inter-frequency or inter-system neighboring cell, or perform measurement on an inter-frequency or inter-system neighboring cell.

In some embodiments, the processor 710 is configured to control RRM measurement according to the measurement performance of the first object in a case that the terminal meets a first preset condition, where
the first preset condition includes at least one of the following:
the terminal receives system information SI, or receives a paging message, or monitors an advance indication signal, or executes random access, or performs camping on a second BWP of a present cell (that is, the terminal camps on the second BWP), so that frequent handover of the terminal between the second BWP and the first IBWP can be avoided;
a present cell is configured with an NCD SSB, so that frequent handover of the terminal between the second BWP and the first IBWP can be avoided;
a neighboring cell is configured with an NCD SSB, so that frequent handover of the terminal between the second BWP and the first IBWP can be avoided;
a random access-related configuration is configured on a second BWP of a present cell and/or a neighboring cell, so that frequent handover of the terminal between the second BWP and the first IBWP can be avoided, where the random access-related configuration is a configuration corresponding to random access, such as a preamble, an RACH resource, and an RO;
an S-Measure criterion is met, where for example, a condition for meeting the S-Measure criterion may be: measurement performance of a present cell is greater than a preset threshold, so that only the terminal in a cell center controls RRM measurement according to the measurement performance of the first object, and a scenario in which measurement on an NCD SSB is used to control RRM measurement can be limited, thereby avoiding possible degradation of mobility performance;
cell measurement performance is determined according to measurement performance of the NCD SSB of the second BWP, or measurement performance of the NCD SSB of the second BWP can represent cell measurement performance, or measurement performance of the NCD SSB of the second BWP can replace measurement performance of the CD SSB of the first BWP, so that frequent handover of the terminal between the second BWP and the first IBWP can be avoided; and
network indication information is received, where the network indication information is used to configure any one of the following: performing a cell selection or reselection operation according to measurement performance of the NCD SSB of the second BWP; performing a cell selection or reselection operation according to measurement performance of the NCD SSB of the second BWP and measurement performance of the CD SSB of the first BWP; an R criterion according to measurement performance of the NCD SSB of the second BWP; an S criterion according to measurement performance of the NCD SSB of the second BWP; and one of the foregoing preset conditions, so that frequent handover of the terminal between the second BWP and the first IBWP can be avoided.

In this embodiment, RRM measurement is controlled according to the measurement performance of the first object in a case that the first preset condition is met, so that a scenario in which measurement on an NCD SSB is used to control RRM measurement can be limited, thereby avoiding possible degradation of mobility performance.

In some embodiments, the processor 710 is configured to: in a case that the terminal meets the first preset condition, control RRM measurement according to the measurement performance of the NCD SSB of the second BWP; and/or control RRM measurement on an NCD SSB of a second BWP of an intra-frequency or inter-frequency or inter-system neighboring cell according to the measurement performance of the NCD SSB of the second BWP.

In some embodiments, the processor 710 is configured to: in a case that measurement performance of an NCD SSB of a second BWP of a present cell is greater than or equal to a first preset threshold, perform at least one of the following: not performing measurement on an intra-frequency neighboring cell, not performing measurement on an inter-frequency or inter-system neighboring cell, and not measurement on a CD SSB of the present cell; or
in a case that measurement performance of an NCD SSB of a second BWP of a present cell is less than or equal to a second preset threshold, perform at least one of the following: performing measurement on an intra-frequency neighboring cell, performing measurement on an inter-frequency or inter-system neighboring cell, and performing measurement on a CD SSB of the present cell.

In some embodiments, the processor 710 is configured to: in a case that measurement performance of an NCD SSB of a second BWP of a present cell is greater than or equal to a third preset threshold and measurement performance of a CD SSB of a first BWP is greater than or equal to an eleventh preset threshold, perform at least one of the following: not performing measurement on an intra-frequency neighboring cell, and not performing measurement on an inter-frequency or inter-system neighboring cell; or
in a case that measurement performance of an NCD SSB of a second BWP of a present cell is greater than or equal to a fourth preset threshold and measurement performance of a CD SSB of a first BWP is less than or equal to a twelfth preset threshold, perform at least one of the following: not performing measurement on an intra-frequency neighboring cell, not performing measurement on an inter-frequency or inter-system neighboring cell, performing measurement on an intra-frequency neighboring cell, and performing measurement on an inter-frequency or inter-system neighboring cell; or
in a case that measurement performance of an NCD SSB of a second BWP of a present cell is less than or equal to a fifth preset threshold and measurement performance of a CD SSB of a first BWP is greater than or equal to a thirteenth preset threshold, perform at least one of the following: performing measurement on an intra-frequency neighboring cell, performing measurement on an inter-frequency or inter-system neighboring cell, not performing measurement on an intra-frequency neighboring cell, and not performing measurement on an inter-frequency or inter-system neighboring cell; or
in a case that measurement performance of an NCD SSB of a second BWP of a present cell is less than or equal to a sixth preset threshold and measurement performance of a CD SSB of a first BWP is less than or equal to a fourteenth preset threshold, perform at least one of the following: performing measurement on an intra-frequency neighboring cell, and performing measurement on an inter-frequency or inter-system neighboring cell.

In some embodiments, the processor 710 is configured to: in a case that the measurement performance of the SSB of the current BWP is greater than or equal to a seventh preset threshold, perform at least one of the following: not performing measurement on an intra-frequency neighboring cell, not performing measurement on an inter-frequency or inter-system neighboring cell, and not performing measurement on a CD SSB of a present cell; or
in a case that the measurement performance of the SSB of the current BWP is less than or equal to an eighth preset threshold, perform at least one of the following: performing measurement on an intra-frequency neighboring cell, performing measurement on an inter-frequency or inter-system neighboring cell, and performing measurement on a CD SSB of a present cell.

In some embodiments, the processor 710 is configured to: in a case that measurement performance of a CD SSB of a first BWP of a present cell is greater than or equal to a ninth preset threshold, perform at least one of the following: not performing measurement on an intra-frequency neighboring cell, not performing measurement on an inter-frequency or inter-system neighboring cell, and not performing measurement on an NCD SSB of the present cell; or
in a case that measurement performance of a CD SSB of a first BWP of a present cell is less than or equal to a tenth preset threshold, perform at least one of the following: performing measurement on an intra-frequency neighboring cell, performing measurement on an inter-frequency or inter-system neighboring cell, and performing measurement on an NCD SSB of the present cell.

In some embodiments, the processor 710 is configured to perform at least one of the following:
not performing measurement on an NCD SSB of a second BWP of the intra-frequency neighboring cell; and
not performing measurement on a CD SSB of a first BWP of the intra-frequency neighboring cell; and/or
the processor 710 is configured to perform at least one of the following:
not performing measurement on an NCD SSB of a second BWP of the inter-frequency or inter-system neighboring cell; and
not performing measurement on a CD SSB of a first BWP of the inter-frequency or inter-system neighboring cell; and/or
the processor 710 is configured to perform at least one of the following:
performing measurement on an NCD SSB of a second BWP of the intra-frequency neighboring cell; and
performing measurement on a CD SSB of a first BWP of the intra-frequency neighboring cell; and/or
the processor 710 is configured to perform at least one of the following:
performing measurement on an NCD SSB of a second BWP of the inter-frequency or inter-system neighboring cell; and performing measurement on a CD SSB of a first BWP of the inter-frequency or inter-system neighboring cell.

In some embodiments, in a case that the measurement performance of the NCD SSB of the second BWP of the present cell is greater than or equal to the third preset threshold and the measurement performance of the CD SSB of the first BWP is greater than or equal to the eleventh preset threshold, the processor 710 is configured to perform at least one of the following:
not performing measurement on an NCD SSB of a second BWP of the intra-frequency neighboring cell; and
not performing measurement on a CD SSB of a first BWP of the intra-frequency neighboring cell; and/or
the processor 710 is configured to perform at least one of the following:
not performing measurement on an NCD SSB of a second BWP of the inter-frequency or inter-system neighboring cell; and
not performing measurement on a CD SSB of a first BWP of the inter-frequency or inter-system neighboring cell.

In some embodiments, in a case that the measurement performance of the NCD SSB of the second BWP of the present cell is greater than or equal to the fourth preset threshold and the measurement performance of the CD SSB of the first BWP is less than or equal to the twelfth preset threshold,
that the terminal does not perform measurement on an intra-frequency neighboring cell includes: the terminal does not perform measurement on an NCD SSB of a second BWP of the intra-frequency neighboring cell; and/or
that the terminal does not perform measurement on an inter-frequency or inter-system neighboring cell includes: the terminal does not perform measurement on an NCD SSB of a second BWP of the inter-frequency or inter-system neighboring cell; and/or
that the terminal performs measurement on an intra-frequency neighboring cell includes: the terminal performs measurement on a CD SSB of a first BWP of the intra-frequency neighboring cell; and/or
that the terminal performs measurement on an inter-frequency or inter-system neighboring cell includes: the terminal performs measurement on a CD SSB of a first BWP of the inter-frequency or inter-system neighboring cell.

In some embodiments, in a case that the measurement performance of the NCD SSB of the second BWP of the present cell is less than or equal to the fifth preset threshold and the measurement performance of the CD SSB of the first BWP is greater than or equal to the thirteenth preset threshold,
that the terminal performs measurement on an intra-frequency neighboring cell includes: the terminal performs measurement on an NCD SSB of a second BWP of the intra-frequency neighboring cell; and/or
that the terminal performs measurement on an inter-frequency or inter-system neighboring cell includes: the terminal performs measurement on an NCD SSB of a second BWP of the inter-frequency or inter-system neighboring cell; and/or
that the terminal does not perform measurement on an intra-frequency neighboring cell includes: the terminal does not perform measurement on a CD SSB of a first BWP of the intra-frequency neighboring cell; and/or
that the terminal does not perform measurement on an inter-frequency or inter-system neighboring cell includes: the terminal does not perform measurement on a CD SSB of a first BWP of the inter-frequency or inter-system neighboring cell.

In some embodiments, in a case that the measurement performance of the NCD SSB of the second BWP of the present cell is less than or equal to the sixth preset threshold and the measurement performance of the CD SSB of the first BWP is less than or equal to the fourteenth preset threshold,
that the terminal performs measurement on an intra-frequency neighboring cell includes at least one of the following: the terminal performs measurement on an NCD SSB of a second BWP of the intra-frequency neighboring cell, and the terminal does not perform measurement on a CD SSB of a first BWP of the intra-frequency neighboring cell; and/or
that the terminal performs measurement on an inter-frequency or inter-system neighboring cell includes at least one of the following: the terminal performs measurement on an NCD SSB of a second BWP of the inter-frequency or inter-system neighboring cell, and the terminal performs measurement on a CD SSB of a first BWP of the inter-frequency or inter-system neighboring cell.

In some embodiments, the first preset threshold corresponding to the measurement performance of the NCD SSB is a sum of a threshold corresponding to S-Measure and a first preset offset, where the first preset offset is configured by the network side device or stipulated in a protocol; and/or
the second preset threshold corresponding to the measurement performance of the NCD SSB is a sum of a threshold corresponding to S-Measure and a first preset offset, where the first preset offset is configured by the network side device or stipulated in a protocol.

In some embodiments, the third preset threshold corresponding to the measurement performance of the NCD SSB is a sum of a threshold corresponding to S-Measure and a third preset offset, where the third preset offset is configured by the network side device or stipulated in a protocol; and/or
the fourth preset threshold corresponding to the measurement performance of the NCD SSB is a sum of a threshold corresponding to S-Measure and a fourth preset offset, where the fourth preset offset is configured by the network side device or stipulated in a protocol; and/or
the fifth preset threshold corresponding to the measurement performance of the NCD SSB is a sum of a threshold corresponding to S-Measure and a fifth preset offset, where the fifth preset offset is configured by the network side device or stipulated in a protocol; and/or
the sixth preset threshold corresponding to the measurement performance of the NCD SSB is a sum of a threshold corresponding to S-Measure and a sixth preset offset, where the sixth preset offset is configured by the network side device or stipulated in a protocol.

In some embodiments, the first BWP includes at least one of the following:
an uplink BWP and a downlink BWP;
and/or
the second BWP includes at least one of the following:
an uplink BWP and a downlink BWP.

In some embodiments, a physical broadcast channel PBCH in the CD SSB includes configuration information indicating receiving of system information, and/or a transmit frequency location of the CD SSB is in a frequency location corresponding to a synchronization raster Sync Raster; and
a PBCH in the NCD SSB does not include configuration information indicating receiving of system information, and/or a transmit frequency location of the NCD SSB is not in a frequency location corresponding to a Sync Raster.

An embodiment of this application further provides a readable storage medium. The readable storage medium stores a program or an instruction, and the program or the instruction is executed by a processor to implement the processes of the foregoing measurement method embodiment, and a same technical effect can be achieved. To avoid repetition, details are not described herein again.

The processor is a processor in the terminal in the foregoing embodiment. The readable storage medium includes a computer readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing measurement method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program product. The computer program product is stored in a storage medium, and the computer program product is executed by at least one processor to implement the processes of the foregoing measurement method embodiment, and a same technical effect can be achieved. To avoid repetition, details are not described herein again.

An embodiment of this application further provides a measurement system, including a network side device and a terminal. The terminal may be configured to perform the steps of the foregoing measurement method.

It should be noted that, in this specification, the terms “include,” “comprise,” or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may clearly understand that the method in the foregoing embodiment may be implemented by software in addition to a necessary universal hardware platform or by hardware only. In some embodiments, the technical solutions of this application entirely or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the above implementations, and the above implementations are merely illustrative but not restrictive. Under the enlightenment of this application, a person of ordinary skill in the art can make many forms without departing from the purpose of this application and the protection scope of the claims, all of which fall within the protection of this application.

1. A measurement method, comprising:
obtaining, by a terminal, measurement performance of a first object, wherein the first object comprises any one of the following: a Cell Defining Synchronization Signal Block (CD SSB) of a first Bandwidth Part (BWP) and a Non Cell Defining Synchronization Signal Block (NCD SSB) of a second BWP, or the NCD SSB of the second BWP, wherein the first BWP is a BWP comprises a CD SSB, and the second BWP is a BWP comprises an NCD SSB; and
controlling, by the terminal, Radio Resource Management (RRM) measurement according to the measurement performance of the first object.

2. The measurement method according to claim 1, wherein before obtaining, by the terminal, the measurement performance of the first object, the method further comprises:
receiving, by the terminal, configuration information of the NCD SSB of the second BWP from a network side device.

3. The measurement method according to claim 2, wherein obtaining, by the terminal, the measurement performance of the first object comprises:
performing, by the terminal, measurement according to the configuration information to obtain the measurement performance of the first object.

4. The measurement method according to claim 1, wherein before controlling, by the terminal, the RRM measurement according to the measurement performance of the first object, the method further comprises:
controlling, by the terminal, the RRM measurement according to the measurement performance of the CD SSB of the first BWP.

5. The measurement method according to claim 1, wherein controlling, by the terminal, the RRM measurement according to the measurement performance of the first object comprises any one of the following:
controlling the RRM measurement according to the measurement performance of the CD SSB of the first BWP;
controlling the RRM measurement according to the measurement performance of the CD SSB of the first BWP and the measurement performance of the NCD SSB of the second BWP;
controlling the RRM measurement according to the measurement performance of the NCD SSB of the second BWP; or
controlling the RRM measurement according to the measurement performance of an SSB of a current BWP, wherein the current BWP is a BWP used for performing any one of the following operations: monitoring an SSB, receiving System Information (SI), receiving a paging message, monitoring an advance indication signal, executing random access, or performing camping.

6. The measurement method according to claim 1, wherein controlling the RRM measurement comprises at least one of the following:
not performing, by the terminal, measurement on a CD SSB of a present cell, or performing, by the terminal, measurement on a CD SSB of a present cell;
not performing, by the terminal, measurement on an NCD SSB of a present cell, or performing, by the terminal, measurement on an NCD SSB of a present cell;
not performing, by the terminal, measurement on an intra-frequency neighboring cell, or performing, by the terminal, measurement on an intra-frequency neighboring cell; or
not performing, by the terminal, measurement on an inter-frequency or inter-system neighboring cell, or performing, by the terminal, measurement on an inter-frequency or inter-system neighboring cell.

7. The measurement method according to claim 1, wherein controlling, by the terminal, the RRM measurement according to the measurement performance of the first object comprises:
controlling the RRM measurement according to the measurement performance of the first object when the terminal meets a first preset condition, wherein
the first preset condition comprises at least one of the following that:
the terminal receives System Information (SI), or receives a paging message, or monitors an advance indication signal, or executes random access, or performs camping on a second BWP of a present cell;
a present cell is configured with an NCD SSB;
a neighboring cell is configured with an NCD SSB;
a random access-related configuration is configured on a second BWP of a present cell or a neighboring cell;
an S-Measure criterion is met;
cell measurement performance is determined according to measurement performance of the NCD SSB of the second BWP, or measurement performance of the NCD SSB of the second BWP represents cell measurement performance, or measurement performance of the NCD SSB of the second BWP replaces measurement performance of the CD SSB of the first BWP; or
network indication information is received, wherein the network indication information is used to configure any one of the following: performing a cell selection or reselection operation according to measurement performance of the NCD SSB of the second BWP, performing a cell selection or reselection operation according to measurement performance of the NCD SSB of the second BWP and measurement performance of the CD SSB of the first BWP, an R criterion according to measurement performance of the NCD SSB of the second BWP, an S criterion according to measurement performance of the NCD SSB of the second BWP, or one of the foregoing preset conditions.

8. The measurement method according to claim 7, wherein controlling the RRM measurement according to the measurement performance of the first object when the terminal meets the first preset condition comprises:
when the terminal meets the first preset condition, controlling the RRM measurement according to the measurement performance of the NCD SSB of the second BWP, or controlling the RRM measurement on an NCD SSB of a second BWP of an intra-frequency or inter-frequency or inter-system neighboring cell according to the measurement performance of the NCD SSB of the second BWP.

9. The measurement method according to claim 5, wherein controlling the RRM measurement according to the measurement performance of the NCD SSB of the second BWP comprises:
when measurement performance of an NCD SSB of a second BWP of a present cell is greater than or equal to a first preset threshold, not performing, by the terminal, at least one of the following: measurement on an intra-frequency neighboring cell, measurement on an inter-frequency or inter-system neighboring cell, or measurement on a CD SSB of the present cell; or
when measurement performance of an NCD SSB of a second BWP of a present cell is less than or equal to a second preset threshold, performing, by the terminal, at least one of the following: measurement on an intra-frequency neighboring cell, measurement on an inter-frequency or inter-system neighboring cell, or measurement on a CD SSB of the present cell.

10. The measurement method according to claim 5, wherein controlling the RRM measurement according to the measurement performance of the CD SSB of the first BWP and the measurement performance of the NCD SSB of the second BWP comprises:
when measurement performance of an NCD SSB of a second BWP of a present cell is greater than or equal to a third preset threshold and the measurement performance of a CD SSB of a first BWP is greater than or equal to an eleventh preset threshold, not performing, by the terminal, at least one of the following: measurement on an intra-frequency neighboring cell, or measurement on an inter-frequency or inter-system neighboring cell; or
when measurement performance of an NCD SSB of a second BWP of a present cell is greater than or equal to a fourth preset threshold and measurement performance of a CD SSB of a first BWP is less than or equal to a twelfth preset threshold,
not performing, by the terminal, at least one of the following: measurement on an intra-frequency neighboring cell, or measurement on an inter-frequency or inter-system neighboring cell, or
performing, by the terminal, at least one of the following: measurement on an intra-frequency neighboring cell, or measurement on an inter-frequency or inter-system neighboring cell; or
when measurement performance of an NCD SSB of a second BWP of a present cell is less than or equal to a fifth preset threshold and measurement performance of a CD SSB of a first BWP is greater than or equal to a thirteenth preset threshold,
performing, by the terminal, at least one of the following: measurement on an intra-frequency neighboring cell, or measurement on an inter-frequency or inter-system neighboring cell, or
not performing, by the terminal, at least one of the following: measurement on an intra-frequency neighboring cell, or measurement on an inter-frequency or inter-system neighboring cell; or
when measurement performance of an NCD SSB of a second BWP of a present cell is less than or equal to a sixth preset threshold and measurement performance of a CD SSB of a first BWP is less than or equal to a fourteenth preset threshold, performing, by the terminal, at least one of the following: measurement on an intra-frequency neighboring cell, or measurement on an inter-frequency or inter-system neighboring cell.

11. The measurement method according to claim 5, wherein controlling the RRM measurement according to measurement performance of an SSB of a current BWP comprises:
when the measurement performance of the SSB of the current BWP is greater than or equal to a seventh preset threshold, not performing, by the terminal, at least one of the following: measurement on an intra-frequency neighboring cell, measurement on an inter-frequency or inter-system neighboring cell, or measurement on a CD SSB of a present cell; or
when the measurement performance of the SSB of the current BWP is less than or equal to an eighth preset threshold, performing, by the terminal, at least one of the following: measurement on an intra-frequency neighboring cell, measurement on an inter-frequency or inter-system neighboring cell, or measurement on a CD SSB of a present cell.

12. The measurement method according to claim 5, wherein controlling the RRM measurement according to the measurement performance of the CD SSB of the first BWP comprises:
when measurement performance of a CD SSB of a first BWP of a present cell is greater than or equal to a ninth preset threshold, not performing, by the terminal, at least one of the following: measurement on an intra-frequency neighboring cell, measurement on an inter-frequency or inter-system neighboring cell, or measurement on an NCD SSB of the present cell; or
when measurement performance of a CD SSB of a first BWP of a present cell is less than or equal to a tenth preset threshold, performing, by the terminal, at least one of the following: measurement on an intra-frequency neighboring cell, measurement on an inter-frequency or inter-system neighboring cell, or measurement on an NCD SSB of the present cell.

13. The measurement method according to claim 9,
wherein:
not performing the measurement on the intra-frequency neighboring cell comprises at least one of the following: not performing measurement on an NCD SSB of a second BWP of the intra-frequency neighboring cell, or the terminal does not perform measurement on a CD SSB of a first BWP of the intra-frequency neighboring cell; or
not performing the measurement on the inter-frequency or inter-system neighboring cell comprises at least one of the following: not performing measurement on an NCD SSB of a second BWP of the inter-frequency or inter-system neighboring cell, or not performing measurement on a CD SSB of a first BWP of the inter-frequency or inter-system neighboring cell; or
performing the measurement on the intra-frequency neighboring cell comprises at least one of the following: performing measurement on an NCD SSB of a second BWP of the intra-frequency neighboring cell, or performing measurement on a CD SSB of a first BWP of the intra-frequency neighboring cell; or
performing the measurement on the inter-frequency or inter-system neighboring cell comprises at least one of the following: performing measurement on an NCD SSB of a second BWP of the inter-frequency or inter-system neighboring cell, or performing measurement on a CD SSB of a first BWP of the inter-frequency or inter-system neighboring cell.

14. The measurement method according to claim 10, wherein when the measurement performance of the NCD SSB of the second BWP of the present cell is greater than or equal to the third preset threshold and the measurement performance of the CD SSB of the first BWP is greater than or equal to the eleventh preset threshold,
not performing the measurement on the intra-frequency neighboring cell comprises at least one of the following: not performing measurement on an NCD SSB of a second BWP of the intra-frequency neighboring cell, or not performing measurement on a CD SSB of a first BWP of the intra-frequency neighboring cell; or
not performing the measurement on the inter-frequency or inter-system neighboring cell comprises at least one of the following: not performing measurement on an NCD SSB of a second BWP of the inter-frequency or inter-system neighboring cell, or not performing measurement on a CD SSB of a first BWP of the inter-frequency or inter-system neighboring cell.

15. The measurement method according to claim 10, wherein when the measurement performance of the NCD SSB of the second BWP of the present cell is greater than or equal to the fourth preset threshold and the measurement performance of the CD SSB of the first BWP is less than or equal to the twelfth preset threshold,
not performing the measurement on the intra-frequency neighboring cell comprises: not performing measurement on an NCD SSB of a second BWP of the intra-frequency neighboring cell; or
not performing the measurement on the inter-frequency or inter-system neighboring cell comprises: not performing measurement on an NCD SSB of a second BWP of the inter-frequency or inter-system neighboring cell; or
performing the measurement on the intra-frequency neighboring cell comprises: performing measurement on a CD SSB of a first BWP of the intra-frequency neighboring cell; or
performing the measurement on the inter-frequency or inter-system neighboring cell comprises: performing measurement on a CD SSB of a first BWP of the inter-frequency or inter-system neighboring cell.

16. The measurement method according to claim 10, wherein when the measurement performance of the NCD SSB of the second BWP of the present cell is less than or equal to the fifth preset threshold and the measurement performance of the CD SSB of the first BWP is greater than or equal to the thirteenth preset threshold,
performing the measurement on the intra-frequency neighboring cell comprises: performing measurement on an NCD SSB of a second BWP of the intra-frequency neighboring cell; or
performing the measurement on the inter-frequency or inter-system neighboring cell comprises: performing measurement on an NCD SSB of a second BWP of the inter-frequency or inter-system neighboring cell; or
not performing the measurement on the intra-frequency neighboring cell comprises: not performing measurement on a CD SSB of a first BWP of the intra-frequency neighboring cell; or
not performing the measurement on the inter-frequency or inter-system neighboring cell comprises: not performing measurement on a CD SSB of a first BWP of the inter-frequency or inter-system neighboring cell.

17. The measurement method according to claim 10, wherein when the measurement performance of the NCD SSB of the second BWP of the present cell is less than or equal to the sixth preset threshold and the measurement performance of the CD SSB of the first BWP is less than or equal to the fourteenth preset threshold,
performing the measurement on the intra-frequency neighboring cell comprises at least one of the following: performing measurement on an NCD SSB of a second BWP of the intra-frequency neighboring cell, or not performing measurement on a CD SSB of a first BWP of the intra-frequency neighboring cell; or
performing the measurement on the inter-frequency or inter-system neighboring cell comprises at least one of the following: performing measurement on an NCD SSB of a second BWP of the inter-frequency or inter-system neighboring cell, or performing measurement on a CD SSB of a first BWP of the inter-frequency or inter-system neighboring cell.

18. The measurement method according to claim 1,
wherein:
the first BWP comprises at least one of the following:
an uplink BWP or a downlink BWP;
or
the second BWP comprises at least one of the following:
an uplink BWP or a downlink BWP.

19. A terminal, comprising: a processor; and a memory having a program or an instruction stored thereon, wherein the program or the instruction, when executed by the processor, causes the processor to implement operations, comprising:
obtaining measurement performance of a first object, wherein the first object comprises any one of the following: a Cell Defining Synchronization Signal Block (CD SSB) of a first Bandwidth Part (BWP) and a Non Cell Defining Synchronization Signal Block (NCD SSB) of a second BWP, or the NCD SSB of the second BWP, wherein the first BWP is a BWP comprises a CD SSB, and the second BWP is a BWP comprises an NCD SSB; and
controlling Radio Resource Management (RRM) measurement according to the measurement performance of the first object.

20. A non-transitory computer-readable storage medium storing a program or an instruction that, when executed by a processor, causes the processor to implement operations, comprising:
obtaining measurement performance of a first object, wherein the first object comprises any one of the following: a Cell Defining Synchronization Signal Block (CD SSB) of a first Bandwidth Part (BWP) and a Non Cell Defining Synchronization Signal Block (NCD SSB) of a second BWP, or the NCD SSB of the second BWP, wherein the first BWP is a BWP comprises a CD SSB, and the second BWP is a BWP comprises an NCD SSB; and
controlling Radio Resource Management (RRM) measurement according to the measurement performance of the first object.
